(19) United States
(12) Patent Application Publication
(10) Pub. No.: US 2024/0046110 A1
(43) Pub. Date: Feb. 8, 2024

(54) MULTI-AGENT-BASED REINFORCEMENT LEARNING SYSTEM AND METHOD THEREFOR

(71) Applicants: HYUNDAI MOTOR COMPANY, Seoul (KR); KIA CORPORATION, Seoul (KR)

(72) Inventors: Dong Hoon Jeong, Seongnam-si (KR); Jung Hwan Bang, Seoul (KR); Hyung Seuk Ohn, Seoul (KR); Won Seok Jeon, Anyang-si (KR); Ki Sang Kim, Seoul (KR); Byeong Wook Jeon, Seoul (KR); Dong Hoon Won, Suwon-si (KR); Hee Yeon Nah, Seoul (KR)

(73) Assignees: HYUNDAI MOTOR COMPANY, Seoul (KR); KIA CORPORATION, Seoul (KR)

(21) Appl. No.: 18/097,677

(22) Filed: Jan. 17, 2023

(30) Foreign Application Priority Data
Aug. 8, 2022 (KR) 10-2022-0098726

(51) Int. Cl. G06N 3/092

(52) U.S. Cl. CPC G06N 3/092

(57) ABSTRACT

Disclosed are a multi-agent-based reinforcement learning system and method therefor. The multi-agent-based reinforcement learning system includes: a slave agent configured to: store a data set collected in each state of a first environment in a first buffer, store a data set received from a master agent in the first buffer, and learn a Q-function based on the data set stored in the first buffer; and the master agent configured to store a data set collected in each state of a second environment in a second buffer; transmit the data set to the slave agent; update a Q-function matched with the slave agent among a plurality of Q-functions; and perform reinforcement learning based on the data set stored in the second buffer.

### CROSS-REFERENCE TO RELATED APPLICATION

This application claims the benefit of and priority to Korean Patent Application No. 10-2022-0098726, filed in the Korean Intellectual Property Office on Aug. 8, 2022, the entire contents of which are incorporated herein by reference.

### TECHNICAL FIELD

The present disclosure relates to a technique for performing reinforcement learning based on multiple agents.

### BACKGROUND

In general, reinforcement learning is learning which action is optimal to take in the current state. Whenever an action is taken, a reward is given in the environment and learning proceeds to maximize the reward.

In this case, the state is a set of values indicating what the situation is at the current time, where the state at a specific time ‘t’ is expressed as sₜ. An action is an option that can be taken in a state, where the action taken in the state s t at a specific time is expressed as at. A reward is a gain corresponding to an action, where the reward for aₜ is expressed as rₜ. In this case, the state (new state) changed by aₜ is expressed as sₜ₊₁.

The protagonist and subject (computer program) of such reinforcement learning (i.e., the subject of learning and acting in the environment at the same time) is called an agent. The agent includes an actor and a critic. The critic estimates a state-action value (Q-value) for each action, and the actor selects an optimal action based on the values of the actions. In particular, the critic updates a parameter of a value function as reinforcement learning, and the actor updates a parameter of a policy function as the reinforcement learning.

Recently, the concept of reinforcement learning has been further specified, but reinforcement learning itself has the property of learning an action strategy by repeating trial-and-error. Thus, when placed in an environment in which it has not learned, it is difficult to accurately evaluate the value of that state, so that an erratic action strategy may be taken. For example, a value and action strategy established in an environment where there is no noise in a signal may be a strategy that does not work well in an environment in which noise is present or, in a severe case, causes great damage.

Therefore, there is a need to provide a method capable of improving the performance of model-free reinforcement learning even in an environment in which noise is present.

The matters described in this background section are intended to promote an understanding of the background of the disclosure and may include matters that are not already known to those of ordinary skill in the art.

### SUMMARY

The present disclosure has been made to solve the above-mentioned problems occurring in the prior art while advantages achieved by the prior art are maintained intact.

An aspect of the present disclosure provides a multi-agent-based reinforcement learning system and method capable of learning an action strategy robust to disturbance, a very stable learning process, and improving learning efficiency. The multi-agent-based reinforcement learning system includes a master agent that performs reinforcement learning in different environments and at least one slave agent, The master agent provides its own experience (sₜ, aₜ, rₜ, sₜ₊₁) to each slave agent and uses the value function (Q-function) of each slave agent for its own reinforcement learning.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, a multi-agent-based reinforcement learning system includes a slave agent configured to: store a data set collected in each state of a first environment in a first buffer, store a data set received from a master agent in the first buffer, and learn a Q-function based on the data set stored in the first buffer. The multi-agent-based reinforcement learning system also includes the master agent that is configured to: store a data set collected in each state of a second environment in a second buffer, transmit the data set to the slave agent, update a Q-function matched with the slave agent among a plurality of Q-functions, and perform reinforcement learning based on the data set stored in the second buffer.

According to an embodiment, the master agent may transmit the data set to the slave agent with a preset probability.

According to an embodiment, the probability may decrease in proportion to a number of slave agents.

According to an embodiment, the master agent may update the Q-function matched with the slave agent among the plurality of Q-functions with a Q-function obtained from the slave agent.

According to an embodiment, the master agent may extract a preset number of Q-functions randomly from among the plurality of Q-functions and learn the extracted Q-functions.

According to an embodiment, the master agent may be configured to perform randomized ensembled double Q-learning based on the data set stored in the second buffer.

According to an embodiment, the master agent may be installed in a cloud server.

According to an embodiment, the slave agent may be configured to perform double Q-learning based on the data set stored in the first buffer.

According to an embodiment, the slave agent may be installed in a vehicle terminal.

According to an embodiment, the data set may include a state (sₜ) at a time (t), an action (aₜ) selected in the state (sₜ), a reward (rₜ) for the action (aₜ), and a new state (sₜ₊₁) changed by the action (aₜ).

According to an aspect of the present disclosure, a multi-agent-based reinforcement learning method includes: storing, by a master agent, a data set collected in each state of a second environment in a second buffer; transmitting, by the master agent, the data set to a slave agent; storing, by the slave agent, a data set collected in each state of a first environment and the data set received from the master agent in a first buffer; learning, by the slave agent, a Q-function based on the data set stored in the first buffer; updating, by the master agent, a Q-function matched with the slave agent among a plurality of Q-functions; and performing, by the master agent, reinforcement learning based on the data set stored in the second buffer.

According to an embodiment, the transmitting of the data set to the slave agent may include transmitting the data set to the slave agent with a preset probability.

According to an embodiment, the probability may decrease in proportion to a number of slave agents.

According to an embodiment, the updating of the Q-function matched with the slave agent may include updating the Q-function matched with the slave agent among the plurality of Q-functions with a Q-function obtained from the slave agent.

According to an embodiment, the performing of the reinforcement learning may include extracting a preset number of Q-functions randomly from among the plurality of Q-functions and learning the extracted Q-functions.

According to an embodiment, the performing of the reinforcement learning may include performing randomized ensembled double Q-learning based on the data set stored in the second buffer.

According to an embodiment, the learning of the Q-function may include performing double Q-learning based on the data set stored in the first buffer.

### BRIEF DESCRIPTION OF THE DRAWINGS

The above and other objects, features, and advantages of the present disclosure should be more apparent from the following detailed description taken in conjunction with the accompanying drawings:

FIG. 1 is a view illustrating a multi-agent-based reinforcement learning system according to an embodiment of the present disclosure;

FIG. 2 is a view illustrating a detailed configuration of a multi-agent-based reinforcement learning system according to an embodiment of the present disclosure;

FIG. 3 is a view illustrating an example of a reinforcement learning algorithm performed by a slave agent according to an embodiment of the present disclosure;

FIG. 4 is a view illustrating an example of a reinforcement learning algorithm performed by a master agent according to an embodiment of the present disclosure;

FIG. 5 is a first performance analysis diagram of a multi-agent-based reinforcement learning system according to an embodiment of the present disclosure;

FIG. 6A is a second performance analysis diagram of a multi-agent-based reinforcement learning system according to an embodiment of the present disclosure;

FIG. 6B is a graph of an average performance value in a second performance analysis diagram of a multi-agent-based reinforcement learning system according to an embodiment of the present disclosure;

FIG. 7A is an diagram illustrating the performance of a master agent according to an embodiment of the present disclosure;

FIG. 7B is an diagram illustrating the performance of a first slave agent according to an embodiment of the present disclosure;

FIG. 7C is an diagram illustrating the performance of a second slave agent according to an embodiment of the present disclosure;

FIG. 8 is an diagram illustrating the performance of each slave agent according to an embodiment of the present disclosure;

FIG. 9 is a view illustrating an example in which a multi-agent-based reinforcement learning system according to an embodiment of the present disclosure is applied to a three-phase PMSM (permanent magnet synchronous motor);

FIG. 10 is a diagram illustrating an example in which a multi-agent-based reinforcement learning system according to an embodiment of the present disclosure is applied to a GEM;

FIG. 11 is a first performance analysis diagram when a multi-agent-based reinforcement learning system according to an embodiment of the present disclosure is applied to a GEM;

FIG. 12 is a second performance analysis diagram when a multi-agent-based reinforcement learning system according to an embodiment of the present disclosure is applied to a GEM;

FIG. 13 is a flowchart illustrating a multi-agent-based reinforcement learning method according to an embodiment of the present disclosure; and

FIG. 14 is a block diagram illustrating a computing system for executing a multi-agent-based reinforcement learning method according to an embodiment of the present disclosure.

### DETAILED DESCRIPTION

Some embodiments of the present disclosure are described in detail with reference to the drawings. In adding the reference numerals to the components of each drawing, it should be noted that the identical or equivalent component is designated by the identical numeral even when they are displayed on other drawings. Further, in describing embodiments of the present disclosure, detailed descriptions of the related known configuration or function are omitted when it is determined that it interferes with the understanding of embodiments of the present disclosure.

In describing the components of embodiments according to the present disclosure, terms such as “first,” “second,” “A,” “B,” “(a),” “(b),” and the like, may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or to perform that operation or function.

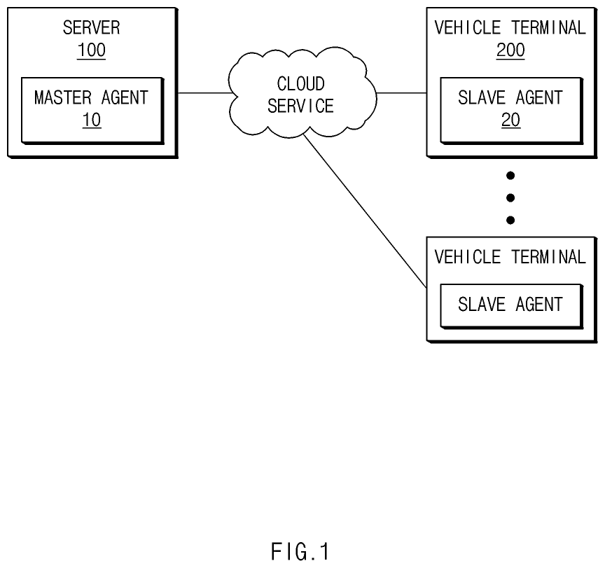

FIG. 1 is a view illustrating a multi-agent-based reinforcement learning system according to an embodiment of the present disclosure.

As shown in FIG. 1, a multi-agent-based reinforcement learning system according to an embodiment of the present disclosure may include a cloud server 100 and at least one vehicle terminal 200.

A master agent 10 is installed in the cloud server 100, and a slave agent 20 is installed in the vehicle terminal 200. In this case, each of the master agent 10 and the slave agent 20 may be implemented as a processor or an application. In addition, although an example in which the slave agent 20 is installed in the vehicle terminal 200 is described, the slave agent 20 may be installed in various devices (PC, smart phone, and the like) that can be connected to the cloud server 100.

The master agent 10 and each slave agent 20 perform reinforcement learning independently of each other in different environments. In this case, the master agent 10 may provide its own experience (sₜ, aₜ, rₜ, sₜ₊₁) to each slave agent 20, and each slave agent 20 may provide its own value function (Q-function) to the master agent 10. Accordingly, the master agent 10 may utilize the value function (Q-function) of each slave agent 20 for its own reinforcement learning.

The master agent 10 may determine the value of an action by randomly selecting a Q-function among its own Q-function and the Q-function of each slave agent 20 and utilize the Q-function of each slave agent 20 in an operation of setting a learning goal as the average of all Q-functions.

The master agent 10 may provide its own experience (sₜ, aₜ, rₜ, sₜ₊₁) to each slave agent. In this case, s t represents the state at a specific time ‘t’ in the environment, aₜ represents the action selected at sₜ, rₜ represents the reward for aₜ, and sₜ₊₁ represents the new state changed by aₜ.

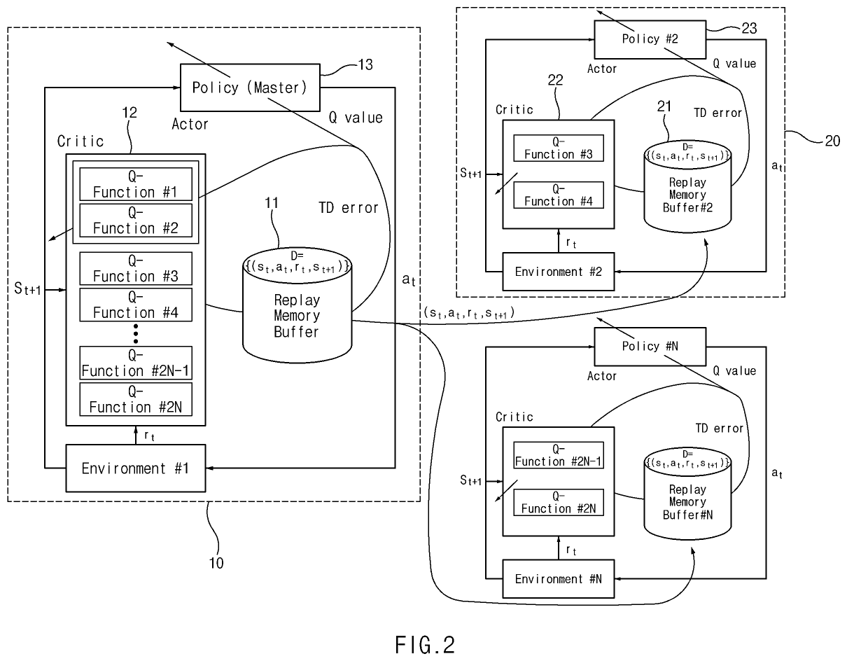

FIG. 2 is a view illustrating a detailed configuration of a multi-agent-based reinforcement learning system according to an embodiment of the present disclosure. FIG. 2 illustrates the detailed configuration of each agent.

First, the master agent 10 may initialize the value function (Q-function) of a critic 12 and the policy function of an actor 13 before learning.

The master agent 10 collects data sets sₜ, aₜ, rₜ, and sₜ₊₁ in each state of environment #1 and stores the collected data sets in a replay memory buffer 11 (i.e., a second buffer). In this case, the master agent 10 transmits the collected data set to each slave agent 20.

The master agent 10 may transmit the data set to each slave agent 20 whenever the data set is collected, or transmit the data set with a probability of 1/N. In this case, the ‘N’ is a natural number that determines the number (N−1) of slave agents 20. For example, when N=3, the number of slave agents 20 is two, and the master agent 10 may deliver the collected data set to the two slave agents 20 with a probability of 1/3.

When the data set stored in the buffer 11 exceeds a certain capacity, the master agent 10 may start reinforcement learning.

The master agent 10 may have a plurality of Q-functions, where the first Q-function #1 and the second Q-function #2 are functions that are not updated with the Q-function of the slave agent 20, and the third Q-function #3 and the fourth Q-function #4 are functions that are updated with the Q-function of the slave agent 20.

Accordingly, the master agent 10 updates its third and fourth Q-functions #3 and #4 to the third and fourth Q-functions #3 and #4 of the slave agent 20. In this case, the master agent may learn an action strategy robust to disturbance by utilizing the Q-function of the slave agent 20.

Then, the master agent 10 may perform randomized ensembled double Q-learning as a kind of reinforcement learning. The master agent 10 may randomly select two Q-functions from among the plurality of Q-functions and perform randomized ensembled double Q-learning to learn the Q-function and the policy function based on the data set stored in the buffer 11. In this case, the master agent 10 may set the learning target (target value) as the average of all Q-functions.

The slave agent 20 may store the data set received from the master agent 10 in a replay memory buffer 21, and when the data set stored in the replay memory buffer 21 exceeds a certain capacity, the slave agent 20 may start reinforcement learning. In this case, the slave agent 20 may improve learning efficiency by using the data set received from the master agent 10 for reinforcement learning.

The slave agent 20 may perform double Q-learning as a type of reinforcement learning. The slave agent 20 may include a third Q-function #3 and a fourth Q-function #4. Based on the data set stored in the replay memory buffer 21, the slave agent 20 may perform double Q-learning to learn the Q-function and the policy function. In this case, the replay memory buffer 21 stores the data set received from the master agent 10.

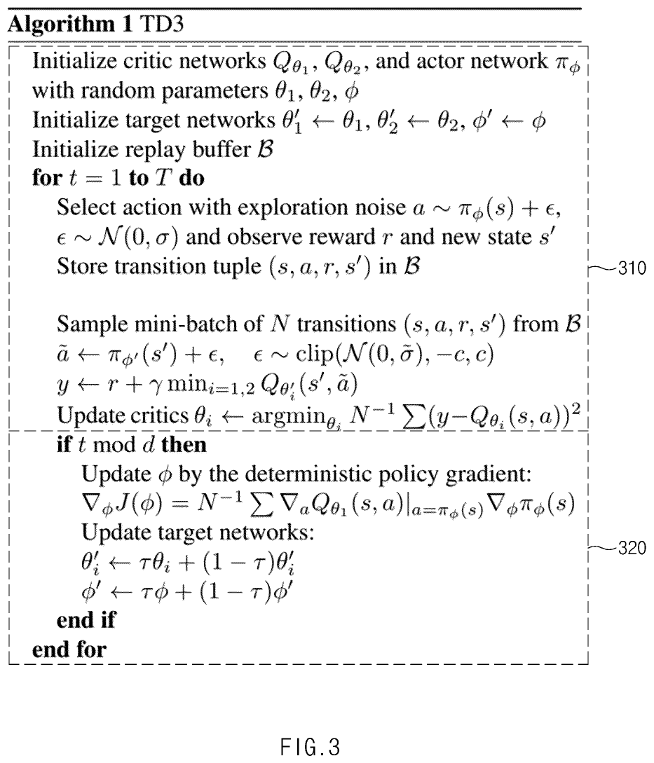

FIG. 3 is a view illustrating an example of a reinforcement learning algorithm performed by a slave agent according to an embodiment of the present disclosure. FIG. 3 illustrates a double Q-learning algorithm, which is one of various reinforcement learning algorithms.

As shown in FIG. 3, reference numeral 310 represents a process in which the slave agent 20 learns the value function (Q-function), and reference numeral 320 represents a process in which the slave agent 20 learns the policy function.

In reference numeral 310, ‘s’ represents the current state, ‘a’ represents the action selected in ‘s’, ‘r’ represents a reward for ‘a’, and ‘s’′ represents a new state changed by ‘a’. In addition, ‘y’ denotes a target value of the Q-function, and denotes a discount factor determining the priority of short-term rewards.

The slave agent 20 observes the state ‘s’ in the environment, selects an action ‘a’ according to the policy, and takes an action in the environment to observe a new state ‘s’′ and a reward ‘r’.

The slave agent 20 extracts the preset number of data sets from the replay memory buffer 21, based on it, determines the value of the third Q-function #3 and the fourth Q-function #4, and determines a smaller value among the determined values as the current value.

The slave agent 20 determines the target value of the third Q-function and the target value of the fourth Q-function by using the extracted data set and learns the third Q-function such that the current value becomes the target value of the third Q-function. In addition, the slave agent 20 learns the fourth Q-function such that the current value becomes the target value of the fourth Q-function. In addition, the slave agent 20 learns the policy function such that the state-action value (Q-value) becomes the minimum value.

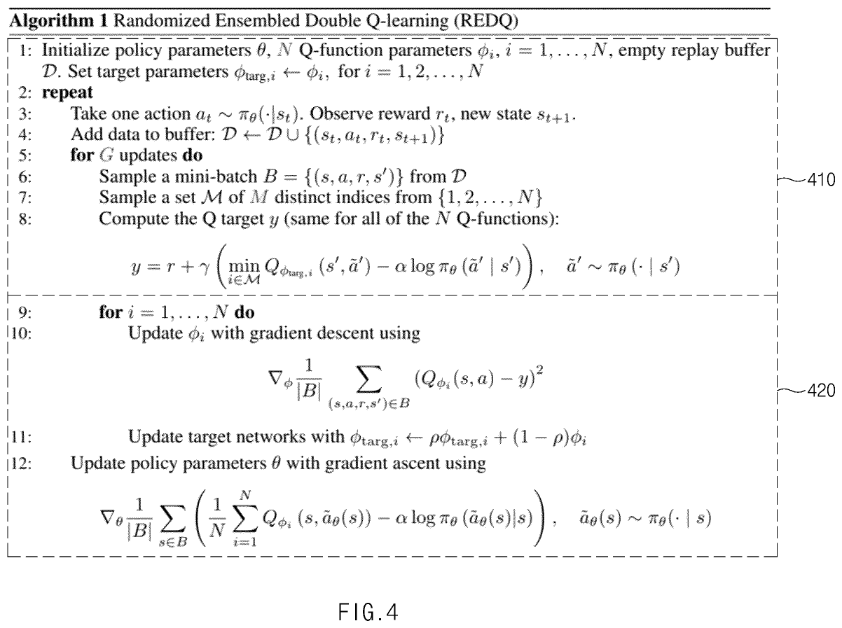

FIG. 4 is a view illustrating an example of a reinforcement learning algorithm performed by a master agent according to an embodiment of the present disclosure. FIG. 4 illustrates a randomized ensembled double Q-learning algorithm which is one of various reinforcement learning algorithms.

As shown in FIG. 4, reference numeral 410 represents a process in which the master agent 10 learns the value function (Q-function), and reference numeral 420 represents a process in which the master agent 10 learns the policy function.

In reference numeral 410, M=2, N=10, G=20, ‘y’ denotes the target value of the Q-function, and ‘γ’ denotes a discount factor determining the priority of short-term rewards.

The randomized ensembled double Q-learning algorithm is based on the double Q-learning algorithm. The double Q-learning algorithm trains two Q-functions, while the randomized ensembled double Q-learning algorithm trains N Q-functions. Accordingly, the master agent 10 may set the average of the N Q-functions as the target values of the two Q-functions selected as the learning object.

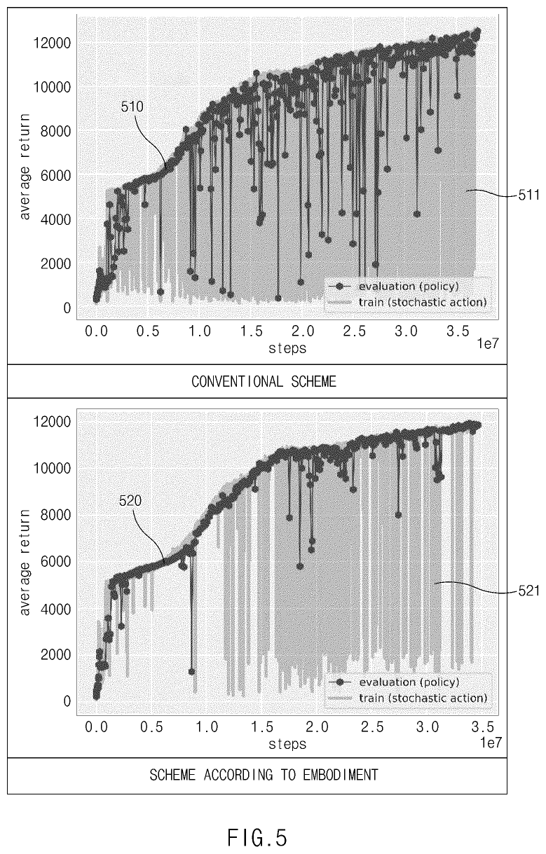

FIG. 5 is a first performance analysis diagram of a multi-agent-based reinforcement learning system according to an embodiment of the present disclosure. FIG. 5 illustrates a reward result in proportion to the distance traveled without falling for a specified time for a humanoid robot simulator (e.g., Mujoco) having 17 joints.

In FIG. 5, the vertical axis represents average return, and the horizontal axis represents steps. Reference numeral 510 indicates a policy curve (deterministic action) according to a conventional scheme. Reference numeral 511 indicates a learning curve (stochastic action) according to a conventional scheme. Reference numeral 520 indicates a policy curve (deterministic action) according to a scheme of an embodiment. Reference numeral 521 indicates a learning curve (stochastic action) according to a scheme of an embodiment.

A conventional scheme may be understood in which the policy curve 520, which is a single agent-based reinforcement learning result, is highly volatile and unstable compared to a scheme according to an embodiment of the present disclosure. This is because the conventional single agent learns the value function depending only on its own experience, so that a new action is highly likely to be wrong. To the contrary, in the scheme according to an embodiment of the present disclosure, the master agent 10 learns the value function by using both its own experience (data set) and the experience (Q-function) of each slave agent 20, so that the master agent 10 accurately knows the value of an action that has not been experienced compared to a single agent, thereby making a new attempt so as not to fail less frequently. In the scheme according to an embodiment of the present disclosure, it may be understood that the value function is averaged with the value function of each slave agent 20 without overfitting the action of the master agent 10.

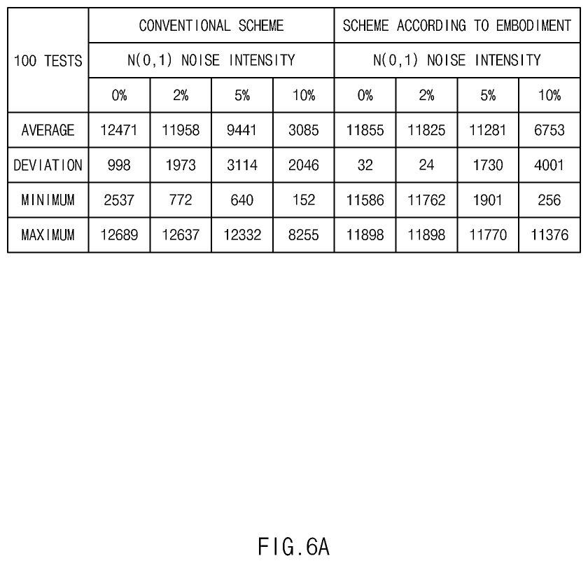

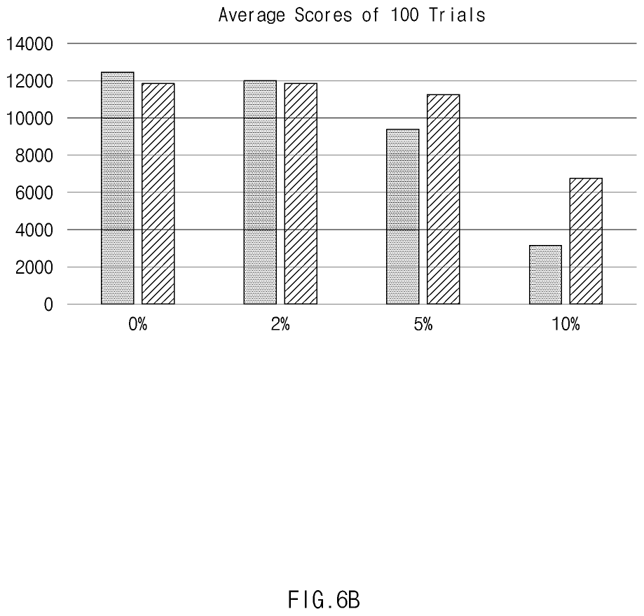

FIG. 6A is a second performance analysis diagram of a multi-agent-based reinforcement learning system according to an embodiment of the present disclosure. FIG. 6A illustrates a reward result in proportion to the distance traveled without falling for a specified time for a humanoid robot simulator (e.g., Mujoco) having 17 joints.

As shown in FIG. 6A, as a table comparing robustness to signal noise, an average performance value, a performance value deviation, the minimum performance value, and the maximum performance value are shown for each intensity of noise, where the performance value may be expressed as a score.

When there is no noise (0%), it may be understood that a conventional scheme has a high average performance value compared to a scheme according of an embodiment of the present disclosure but has a large deviation. This means that even a slight disturbance may cause severe performance degradation.

In order to confirm this, noise (Δx=ε×N(0,1)×x) is injected into an input signal ‘x’, and the change in the result (performance value) of increasing c stepwise such as 0.02, 0.05, was observed. In this case, N (0, 1) means a Gaussian distribution with a mean of ‘0 (zero)’ and a standard deviation of ‘1’.

In the conventional scheme, in a situation of noise 2%, the deviation of the performance value increased until 1973 and the minimum performance value fell to 772, but it may be understood that the deviation of the performance value and the change of the minimum performance value are insignificant in the scheme according to an embodiment of the present disclosure.

In particular, in the 10% noise situation, it may be understood that the conventional scheme reduced the average performance value to ¼ level compared to the 0% noise situation, but the scheme according to an embodiment of the present disclosure has the average performance value reduced to ½ level compared to the 0% noise situation. Thus, it may be understood that the scheme according to an embodiment of the present disclosure is more robust to signal noise than the conventional scheme. When this is shown in a graph, it is as shown in FIG. 6B.

FIG. 6B is a graph of an average performance value in a second performance analysis diagram of a multi-agent-based reinforcement learning system according to an embodiment of the present disclosure.

As shown in FIG. 6B, although there is no significant difference between the performance value according to the conventional scheme and the performance value according to the scheme according to an embodiment of the present disclosure in the absence of signal noise (0%) or the 2% noise situation, it may be understood that as the signal noise increases, the decrease in the performance value according to the conventional scheme is significantly larger than the decrease in the performance value by the scheme according to an embodiment of the present disclosure. Accordingly, it is proved that the scheme according to an embodiment of the present disclosure is robust to signal noise compared to the conventional scheme.

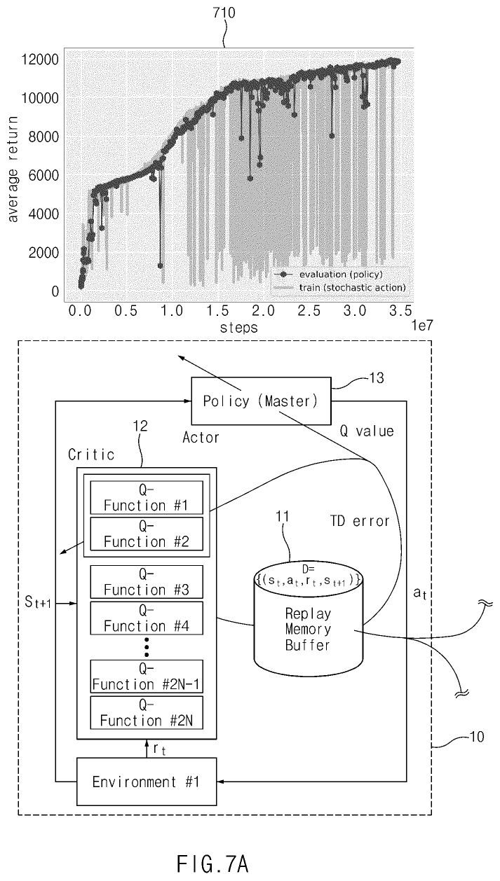

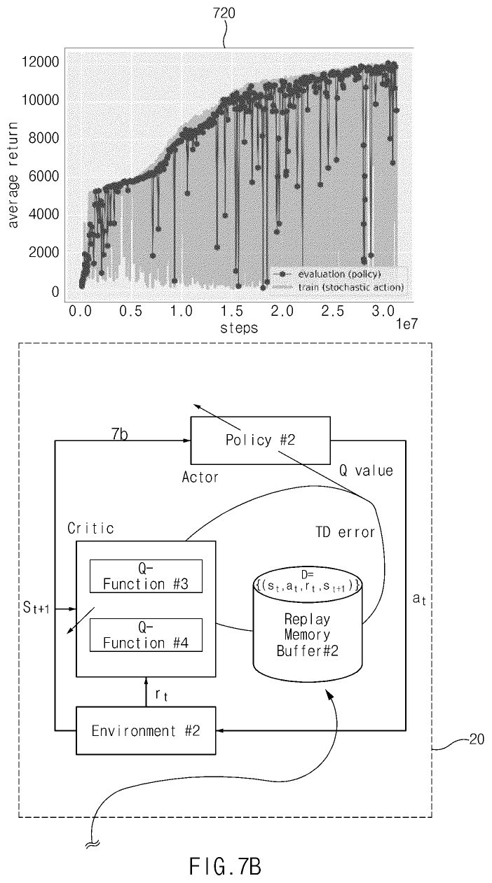

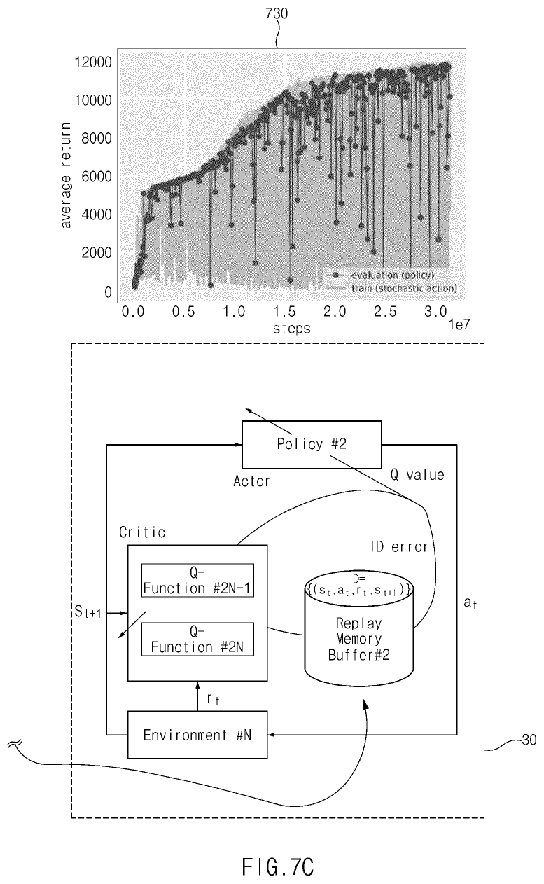

FIG. 7A to 7C are a diagram illustrating the performance of a master agent and each slave agent according to an embodiment of the present disclosure.

As shown in FIG. 7A to 7C, reference numeral 710 indicates the performance graph of the master agent 10, reference numeral 720 indicates the performance graph of the first slave agent 20, and reference numeral 730 indicates the performance graph of a second slave agent 30.

Although the performance graph 720 of the first slave agent 20 and the performance graph 730 of the second slave agent are highly volatile and not stable, similar to the conventional scheme as shown in FIG. 5, the performance graph 710 of the master agent 10 is stable with little volatility as shown in FIG. 5.

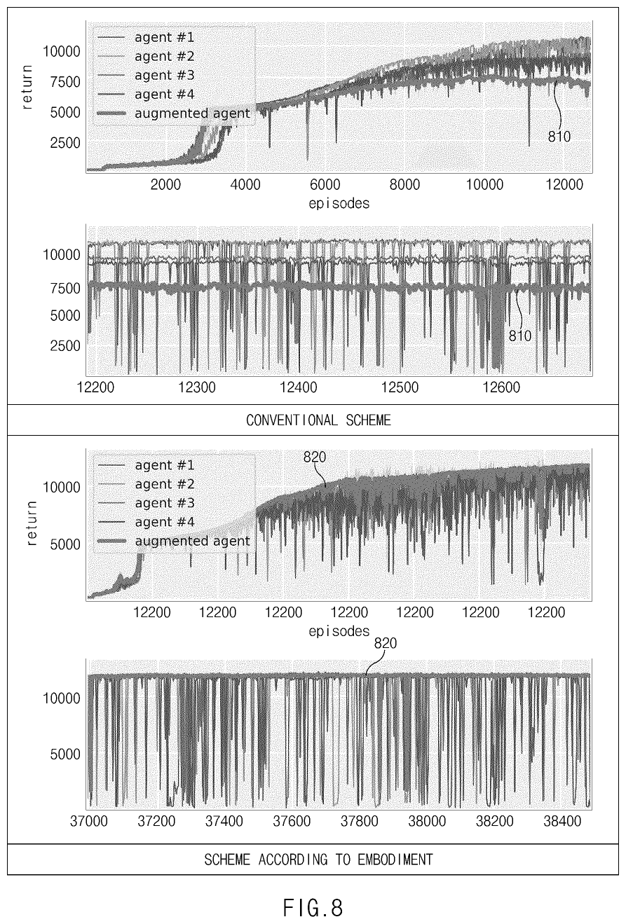

FIG. 8 is a diagram illustrating the performance of each slave agent according to an embodiment of the present disclosure.

As shown in FIG. 8, the vertical axis of each graph indicates returns, and the horizontal axis indicates episodes. In this case, the return represents a cumulative reward, and the episode represents, as a trajectory, a sequence that an agent has gone through from an initial state to an end state.

The conventional scheme shows the result of the slave agents #1 to #4 performing reinforcement learning independently of each other in a state where the experience (data set) of the master agent 10 is not shared at all. The scheme according to an embodiment of the present disclosure shows the result of the slave agents #1 to #4 performing reinforcement learning dependently on each other in a state where the experience (data set) of the master agent 10 is partially shared.

It may be understood that the performance 810 of the master agent 10 is stagnant or rather decreases in the conventional manner, whereas in the scheme according to an embodiment of the present disclosure, the performance 820 of the master agent 10 is stably improved.

This is also proven through the “policy iteration convergence” theory that an optimal policy can be found when the policy is improved after learning the Q-function (value function) as an action following the policy in a state where the policy is fixed. The policy is not optimally improved because the “policy iteration convergence” theory is not established in the conventional scheme using the Q-function of the slave agent that does not reflect the experience following the policy of the master agent 10.

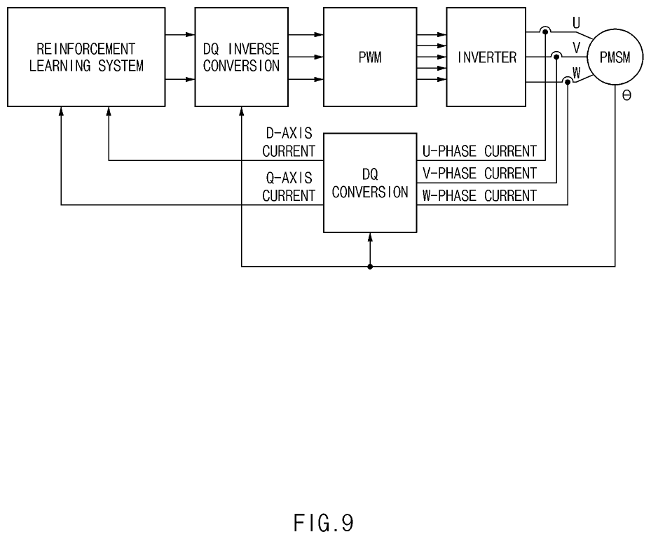

FIG. 9 is a view illustrating an example in which a multi-agent-based reinforcement learning system according to an embodiment of the present disclosure is applied to a three-phase PMSM (permanent magnet synchronous motor).

As shown in FIG. 9, a multi-agent-based reinforcement learning system according to an embodiment of the present disclosure may replace the function of a dq feed-forward compensator, and may perform the d-axis control and the q-axis control based on the output of the dq forward compensator, a d-axis command and a q-axis command to output the d-axis control result and the q-axis control result.

Such a reinforcement learning system may learn an optimal control strategy of voltage duty ratios d and q, such that the motor torque follows the target torque for current phase relationship and vector control of a permanent magnet synchronous motor (PMSM).

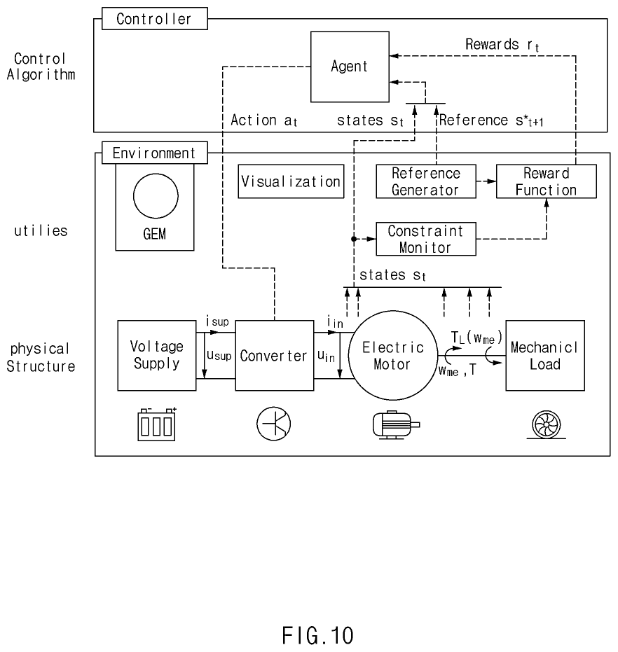

FIG. 10 is a diagram illustrating an example in which a multi-agent-based reinforcement learning system according to an embodiment of the present disclosure is applied to GEM.

As shown in FIG. 10, a multi-agent-based reinforcement learning system according to an embodiment of the present disclosure may receive five variables (a motor RPM (rotations per minute), a motor actual torque, a target torque, iq, and id) determined by gym-electric-motor (GEM) and learn an output strategy of Q-voltage duty and d voltage duty that minimizes the torque error.

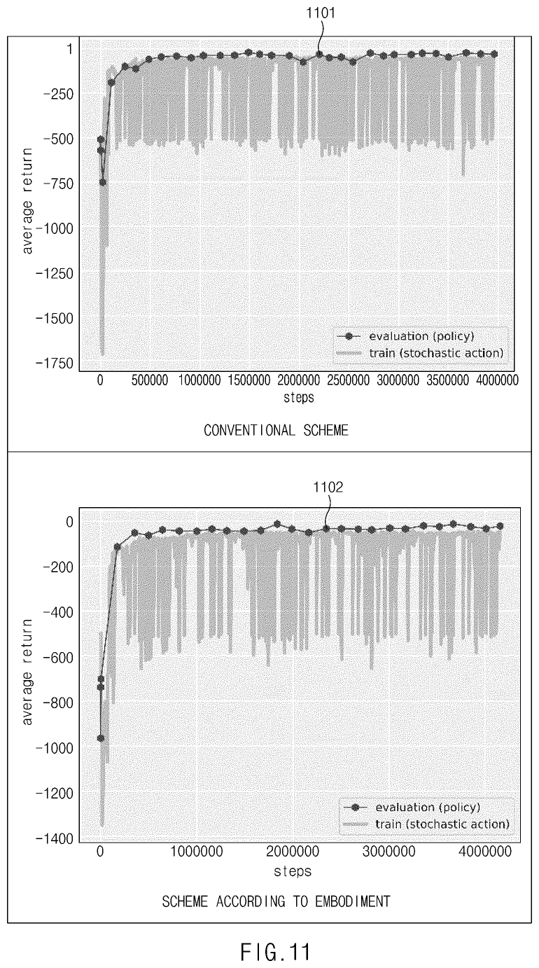

FIG. 11 is a first performance analysis diagram when a multi-agent-based reinforcement learning system according to an embodiment of the present disclosure is applied to a GEM.

As shown in FIG. 11, a single agent-based reinforcement learning system (i.e., a conventional scheme) has a policy curve 1101 which is highly volatile and unstable, whereas a scheme according to an embodiment of the present disclosure has a policy curve 1102 which is not volatile and stable compared to the conventional scheme.

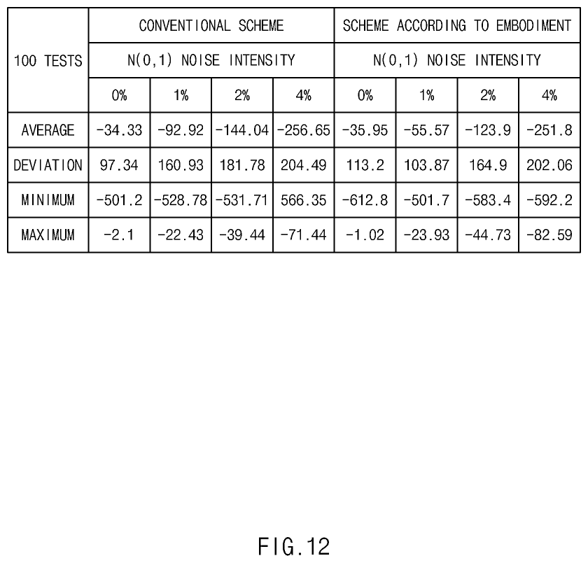

FIG. 12 is a second performance analysis diagram when a multi-agent-based reinforcement learning system according to an embodiment of the present disclosure is applied to the GEM.

As shown in FIG. 12, in a scheme according to an embodiment of the present disclosure, as the intensity of noise increases, the decrease in the average performance value is small, and the deviation in the performance value is also small compared to the conventional scheme. Thus, even when embodiments of the present disclosure are applied to the GEM, it may be understood that the signal noise robustness is maintained compared to the conventional scheme.

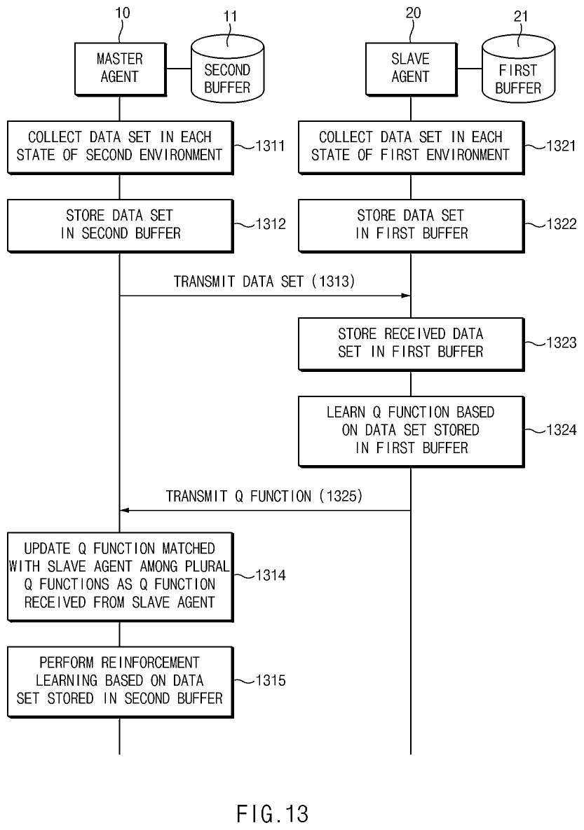

FIG. 13 is a flowchart illustrating a multi-agent-based reinforcement learning method according to an embodiment of the present disclosure.

First, in 1311, the master agent 10 collects the data set in each state of the second environment.

In 1312, the master agent 10 stores the collected data set in the second buffer 11.

In 1313, the master agent 10 transmits the collected data set to the slave agent 20.

In 1321, the slave agent 20 collects the data set in each state of the first environment.

In 1322, the slave agent 20 stores the collected data set in the first buffer 21.

In 1323, the slave agent 20 stores the data set received from the master agent 10 in the first buffer 21.

In 1324, the slave agent 20 learns the Q-function based on the data set stored in the first buffer 21.

In 1325, the slave agent 20 transmits the Q-function to the master agent 10.

In 1314, the master agent 10 updates the Q-function matched with the slave agent among a plurality of Q-functions as the Q-function received from the slave agent 20. In this case, the master agent 10 may have the plurality of Q-functions.

In 1315, the master agent 10 performs reinforcement learning based on the data set stored in the second buffer 11.

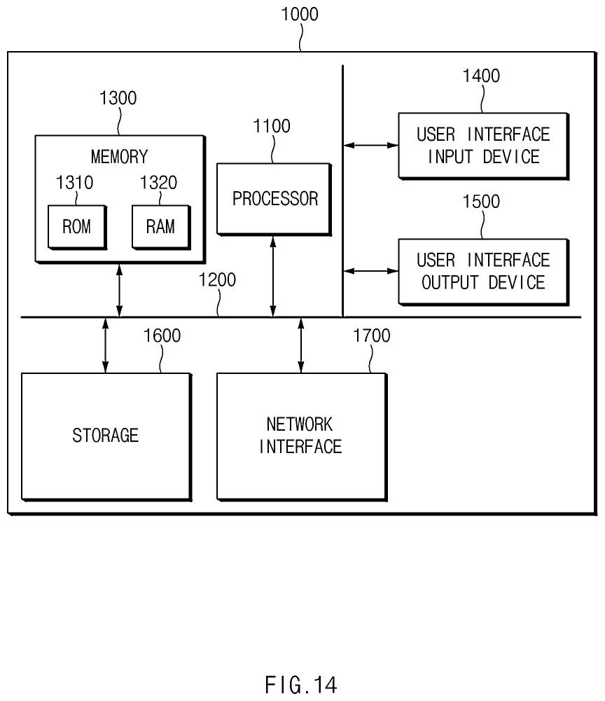

FIG. 14 is a block diagram illustrating a computing system for executing a multi-agent-based reinforcement learning method according to an embodiment of the present disclosure.

Referring to FIG. 14, the multi-agent-based reinforcement learning method according to an embodiment of the present disclosure described above may be implemented through a computing system. A computing system 1000 may include: at least one processor 1100; a memory 1300; a user interface input device 1400; a user interface output device 1500; storage 1600; and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to embodiments of the present disclosure may be implemented directly by hardware executed by the processor 1100, a software module, or a combination thereof. The software module may reside in a storage medium (i.e., the memory 1300 and/or the storage 1600), such as a RAM (random-access memory), a flash memory, a ROM (read-only memory), an EPROM (erasable programmable read-only memory), an EEPROM (electrically erasable programmable read-only memory), a register, a hard disk, solid state drive (SSD), a detachable disk, or a CD-ROM (compact disc read-only memory). The storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to embodiments, there are provided a master agent and at least one slave agent that perform reinforcement learning in different environments, where the master agent provides its own experience (sₜ, aₜ, rₜ, sₜ₊₁) to each slave agent and uses the value function (Q-function) of each slave agent for its own reinforcement learning, thereby learning an action strategy robust to disturbance, stabilizing the learning process, and improving the efficiency of learning.

Specifically, the master agent, according to embodiments, may determine the value of the action by randomly selecting one from its own Q-function and Q-functions of the slave agents, and utilize the experience (Q-function) of each slave agent in the process of setting the learning goal as the average of all Q-functions, so that it is possible to prevent overfitting of the Q-function. In addition, the master agent may take a more robust action strategy than each slave agent for noisy input signals. The master agent, according to embodiments, may learn an action strategy robust to disturbance.

In addition, according to embodiments, by reflecting the experience (Q-function) of each slave agent that the master agent has not experienced, new attempts may be more likely to be similar to the experiences the master agent knows, so the master agent may proceed with learning stably. The master agent, according to embodiments, may perform the learning process stably.

In addition, the master agent, according to embodiments may improve the learning efficiency of each slave agent by providing its own experience (sₜ, aₜ, rₜ, sₜ₊₁) to each slave agent, thereby improving the learning efficiency of the master agent.

Although embodiments of the present disclosure have been described for illustrative purposes, those having ordinary skill in the art should appreciate that various modifications, additions and substitutions are possible, without departing from the scope and spirit of the disclosure.

The embodiments disclosed in the present disclosure are provided for the sake of descriptions, not limiting the technical concepts of the present disclosure, and it should be understood that such embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A multi-agent-based reinforcement learning system comprising:
a slave agent configured to:
store a data set collected in each state of a first environment in a first buffer,
store a data set received from a master agent in the first buffer, and
learn a Q-function based on the data set stored in the first buffer; and
the master agent configured to:
store a data set collected in each state of a second environment in a second buffer,
transmit the data set to the slave agent,
update a Q-function matched with the slave agent among a plurality of Q-functions, and
perform reinforcement learning based on the data set stored in the second buffer.

2. The multi-agent-based reinforcement learning system of claim 1, wherein the master agent is configured to transmit the data set to the slave agent with a preset probability.

3. The multi-agent-based reinforcement learning system of claim 2, wherein the preset probability is configured to decrease in proportion to a number of slave agents.

4. The multi-agent-based reinforcement learning system of claim 2, wherein the master agent is configured to update the Q-function matched with the slave agent among the plurality of Q-functions with a Q-function obtained from the slave agent.

5. The multi-agent-based reinforcement learning system of claim 1, wherein the master agent is configured to extract a preset number of Q-functions randomly from among the plurality of Q-functions and learn the extracted Q-functions.

6. The multi-agent-based reinforcement learning system of claim 1, wherein the master agent is configured to perform randomized ensembled double Q-learning based on the data set stored in the second buffer.

7. The multi-agent-based reinforcement learning system of claim 1, wherein the master agent is configured to be installed in a cloud server.

8. The multi-agent-based reinforcement learning system of claim 1, wherein the slave agent is configured to perform double Q-learning based on the data set stored in the first buffer.

9. The multi-agent-based reinforcement learning system of claim 1, wherein the slave agent is configured to be installed in a vehicle terminal.

10. The multi-agent-based reinforcement learning system of claim 1, wherein the data set includes a state (sₜ) at a time (t), an action (aₜ) selected in the state (sₜ), a reward (rₜ) for the action (aₜ), and a new state (sₜ+1) changed by the action (aₜ).

11. A multi-agent-based reinforcement learning method comprising:
storing, by a master agent, a data set collected in each state of a second environment in a second buffer;
transmitting, by the master agent, the data set to a slave agent;
storing, by the slave agent, a data set collected in each state of a first environment and the data set received from the master agent in a first buffer;
learning, by the slave agent, a Q-function based on the data set stored in the first buffer;
updating, by the master agent, a Q-function matched with the slave agent among a plurality of Q-functions; and
performing, by the master agent, reinforcement learning based on the data set stored in the second buffer.

12. The multi-agent-based reinforcement learning method of claim 11, wherein transmitting the data set to the slave agent includes transmitting the data set to the slave agent with a preset probability.

13. The multi-agent-based reinforcement learning method of claim 12, wherein the preset probability decreases in proportion to a number of slave agents.

14. The multi-agent-based reinforcement learning method of claim 11, wherein updating the Q-function matched with the slave agent includes updating the Q-function matched with the slave agent among the plurality of Q-functions with a Q-function obtained from the slave agent.

15. The multi-agent-based reinforcement learning method of claim 11, wherein performing the reinforcement learning includes:
extracting a preset number of Q-functions randomly from among the plurality of Q-functions; and
learning the extracted Q-functions.

16. The multi-agent-based reinforcement learning method of claim 11, wherein performing the reinforcement learning includes performing randomized ensembled double Q-learning based on the data set stored in the second buffer.

17. The multi-agent-based reinforcement learning method of claim 11, wherein learning the Q-function includes performing double Q-learning based on the data set stored in the first buffer.

18. The multi-agent-based reinforcement learning method of claim 11, wherein the data set includes:
a state (sₜ) at a time (t);
an action (aₜ) selected in the state (sₜ); a reward (rₜ) for the action (aₜ); and
a new state (sₜ+1) changed by the action (aₜ).
